(19) United States
(12) Patent Application Publication
(10) Pub. No.: US 2015/0189893 A1
(43) Pub. Date: Jul. 9, 2015

(54) Method for Treating Fresh Fruits and Fresh Vegetable Products

(71) Applicant: Kel Eugene Lemons, Placerville, CA (US)

(72) Inventor: Kel Eugene Lemons, Placerville, CA (US)

(73) Assignee: Kel Eugene Lemons, Pollock Pines, CA (US)

(21) Appl. No.: 14/523,921

(22) Filed: Oct. 26, 2014

Related U.S. Application Data
(60) Provisional application No. 61/923,879, filed on Jan. 6, 2014.

(51) Int. Cl. A23B 7/157; A23B 7/16; A23B 7/10; A01N 59/00; A01N 37/02

(52) U.S. Cl. CPC A23B 7/157; A01N 59/00; A01N 37/02; A23B 7/10; A23B 7/16; A23V 2002/00

(57) ABSTRACT

Contacting fresh fruits and fresh vegetables with an aqueous solution containing an effective amount of a neutralized silicate reduces bacterial and or fungal contamination of the fresh fruits and fresh vegetable product or retards bacterial and or fungal growth on the fresh fruits and fresh vegetable product or both without any loss to the organoleptic properties or shelf life of the product.

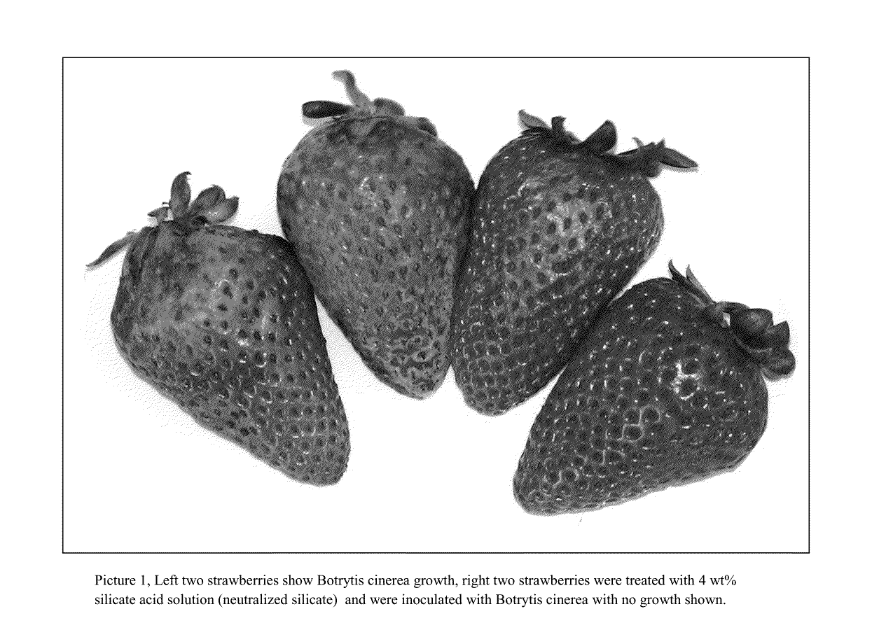

Contacting fresh fruits and fresh vegetables with an aqueous solution containing an effective amount of a neutralized silicate reduces bacterial and or fungal contamination of the product or retards bacterial and or fungal growth on the product or both without any loss to the organoleptic properties or shelf life of the product.

### DESCRIPTION

1. Field of the Invention

This invention relates to an improved method for post harvest treatment of fresh fruits and fresh vegetables to reduce bacterial and or fungal contamination of such products or retard bacterial and or fungal growth on such products.

2. Background of the Invention

Many fresh fruits and fresh vegetables, such as, for example, strawberries, cauliflower, romaine are harvested and packed in the field for direct human consumption or processed further and packaged. Such products may be contaminated with unwanted bacteria and or fungus during harvesting and or processing, which may multiply depending upon the sanitary conditions and cold chain employed in further handling and storage of the fresh fruits and fresh vegetables. Bacterial and or fungal contamination of the fresh fruits and fresh vegetables may cause shelf life reduction, spoilage and possible illness to consumers from the contaminated fresh fruits and fresh vegetables products.

Current treatments using silicates tech using a high pH of greater than 9 pH which those in the art would realize the possible destruction of delicate fruits and vegetables products as well as the possible color, organoleptic and shelf life reduction do to high pH levels. Also those in the art would appreciate that a lower pH (neutralized silicate) would create a very thin coating while not completely polymerizing the silicate, to add an increased hardness and performance to the silicate coating while maintaining hydration and bactericidal and fungicidal effects.

### SUMMARY OF THE INVENTION

In the first aspect, the present invention is directed to a method for treating fresh fruits and fresh vegetables products to reduce bacteria and or fungus contamination of such products or retard bacterial and or fungal growth on such products, comprising contacting the processed product with an aqueous solution comprising an effective amount of a neutralized silicate.

In a first embodiment, the fresh fruits and fresh vegetables is a post-harvest fresh vegetable product romaine.

In a second embodiment, the processed fresh fruits and fresh vegetables is a post-harvest fresh fruit product strawberry.

The treatment method of the present invention allows simple and economical washing of fresh fruits and fresh vegetables products to reduce bacterial and or fungal contamination of such products and or retard bacterial and fungal growth on such products, without any loss to the organoleptic properties of the product or shelf life of the product.

### PREFERRED EMBODIMENTS

In a preferred embodiment, the treatment solution of the present invention is effective as a bactericide and fungicide under the treatment conditions and killing bacteria and fungus is one mechanism by which the treatment of the present invention reduces contamination on the fresh fruits and fresh vegetable products.

In another preferred embodiment, the treatment solution of the present invention is effective as bacteria and fungus inhibitor under the treatment conditions used to inhibit bacteria and fungus from growing due to a coating of the neutralized silicate that is attached to the fresh fruit and fresh vegetables is one mechanism by which the treatment of the present invention reduces contamination on the fresh fruits and fresh vegetable products.

As used herein in reference to fresh fruits and fresh vegetable products, the terminology “fresh fruits and vegetables products” means minimal processed fruit and vegetable products that are harvested packaged and directly placed into a consumer market.

As used herein in reference to fresh fruits and fresh vegetable products, the terminology “minimally processed fresh fruits and vegetables products” means minimal processed fruit and vegetable products that are placed into a container or maybe but limited to trimmed, diced, washed, cut, stored, cooled and dried then directly placed into a consumer market.

As used herein in reference to fresh fruits and fresh vegetable products, the terminology “organoleptic properties” means the sensory properties, including the appearance, texture, taste and smell, of such fresh fruits and fresh vegetable products.

As used herein in reference to fresh fruits and fresh vegetables bacterial and or fungal contamination, the terminology “fresh fruits and vegetable contamination” means the bacteria and or fungus that may result in consumer illness, spoilage or reduced shelf life of the fresh fruits and fresh vegetables.

As used herein, the term “water” means tap water, that is, water as available onsite without requiring purification.

The bacterial contamination addressed by the method of the present invention may be gram negative bacteria or gram positive bacteria and includes but not limited to pathogenic bacteria and spoilage bacteria, such as, for example, Listeria monocytogenes, Salmonella typhimurium, Salmonella choleraesuis, Salmonella enteriditis, Escherichia. coli, Camphylobacter sp., Pseudomonus aeruginosa, Serratia liquefaciens, Clostridium sp. and lactic acid forming bacteria, for example, Lactobacillus sp., such as Lactobacillus aviarius.

The fungal contamination addressed by the method of the present invention includes but not limited to spoilage fungus, such as, for example, Alternaria, Aspergillus, Botrytis, Cladosporium, Fusarium, Geotrichum, Monilia, Manoscus, Mortierella, Mucor, Neurospora, Oidium, Oosproa, Penicillium, Rhizopus and Thamnidium.

Suitable silicates include but limited to, for example, sodium disilicates, sodium metasilicates, potassium disilicates, potassium metasilicates, silicon dioxide, calcium silicate, aluminum calcium silicate, magnesium silicate, tricalcium silicate and may be in anhydrous or hydrated form.

Suitable acids for neutralization included but are not limited to organic acids such as sorbic acid, benzoic acid, lactic acid, citric acid, ascorbic acid, salicylic acid, and mineral acids included but not limited to phosphoric acid, nitric acid, sulfuric acid, hydrochloric acid, nitric acid, boric acid, hydrofluoric acid, hydrobromic acid and perchloric acid

In a preferred embodiment, the silicate comprises one or more of anhydrous sodium metasilicate, anhydrous potassium metasilicate, sodium metasilicate pentahydrate, sodium metasilicate hexahydrate and sodium metasilicate nonahydrate. More typically, the silicate comprises one or more of anhydrous sodium metasilicate, anhydrous potassium metasilicate and sodium metasilicate pentahydrate. Even more typically, the silicate comprises one or more of anhydrous sodium metasilicate and anhydrous potassium metasilicate, and one or more of sodium metasilicate pentahydrate and potassium metasilicate pentahydrate.

In one embodiment, the aqueous solution comprises an amount of silicate, typically from greater than 0.001 wt % to 3 wt %, more typically from greater than 0.005 wt % to 4 wt % silicate, and an amount of acid typically from greater than 0.001 wt % to 3 wt %, more typically from greater than 0.005 wt % to 4 wt % acid, the combination as neutralized semi-polymer liquid state silicate effective to reduce bacterial contamination of the food product wherein the ranges are calculated on the basis of the weight of the silicate and acid. In one embodiment, the method of the present invention is suitable as the primary step of a product processing line for reducing bacterial and or fungal contamination of the product.

In an alternative embodiment, the aqueous solution comprises an amount of silicate, typically from greater than 0.0001 wt % to 1 wt %, more typically from greater than 0.0005 wt % to 2 wt % silicate, and an amount of acid typically from greater than 0.0001 wt % to 1 wt %, more typically from greater than 0.0005 wt % to 2 wt % acid, the combination as neutralized semi-polymer liquid state silicate, that is an effective coating to retard bacterial and or fungal growth on the food product, but that is not necessarily sufficient to kill bacteria and or fungal or otherwise reduce bacterial and or fungal contamination of the product.

In one embodiment, the less concentrated silicate and acid solution is used in combination with other treatments, such as, for example, treating the product with aqueous chlorine, bromine, hydrogen peroxide or peracetic acid solution, washing the product with cold water, e.g., at a temperature of from about −1.1° C. to about 8.8° C., cleaning the product with cold water and vacuum, and, either before or after packaging the product for sale, or irradiating the product, wherein the series of treatments are, in combination, effective to reduce bacterial and or fungal contamination of the food product while providing an effective silicate coating for continued inhibition of the bacteria and or fungal growth.

In another embodiment, the aqueous solution consists essentially of a solution of silicate and acid in water. In yet another embodiment, the aqueous solution consists of a solution of silicate and acid and may include a softening agent but not limited to bicarbonate such as sodium bicarbonate, potassium bicarbonate, calcium bicarbonate.

In another embodiment, the aqueous solution consists essentially of a solution of silicate and acid in water. In yet another embodiment, the aqueous solution consists of a solution of silicate and acid and may include a surfactant but not limited to sodium lauryl sulfate, quillaja saponaria.

In one embodiment, the aqueous solution exhibits a pH of from about 6.5 to about 7.8, more typically from about 6.8 to about 7.5.

In another embodiment, the fresh fruits and vegetables products are contacted with the aqueous solution after harvesting and before packaging by dunking or dipping the fresh fruits and vegetables products in the aqueous solution or by spraying or fogging the aqueous solution on the fresh fruits and vegetables products. In a preferred embodiment, the fresh fruits and vegetables products are contacted with the aqueous solution by spraying the aqueous solution under a gage pressure of greater than 0.5 pounds per square inch above atmospheric pressure (psig), more typically from 1 to 30 psig, onto all accessible surfaces of the fresh fruits and vegetables products.

In one embodiment, the aqueous solution is at a temperature of from about 0 to about 29.4° C., more typically from −17 to about 21° C.,, still more typically from about −1° C. to about 15.5° C.

in another embodiment, the fresh fruits and vegetables products are contacted with the aqueous solution for greater than or equal to about 1 second to about 5 minutes, more typically from about 5 seconds to about 2 minutes, and even more typically from about 15 seconds to about 1 minute. The preferred contact times refer to the duration of the active application process, for example, dipping, fogging or spraying, is used to contact the aqueous treatment solution with the fresh fruits and vegetables products. Once applied, the aqueous solution may be allowed to remain on the fresh fruits and vegetables products to allow continued, bactericidal and or fungicidal support and hydration for continued shelf life.

Fresh fruits and vegetables products that have been treated according to the present invention can, immediately after such treatment, are processed according to normal process conditions, such as draining, drying, cooling, and/or packaging for sale. Optionally, the aqueous solution residue may be rinsed from the treated fresh fruits and vegetables products prior to thither processing.

In one embodiment, the aqueous solution is recycled. The recycled aqueous solution may, optionally, be filtered to remove solids prior to recycling. The aqueous solution may be monitored and the composition of the aqueous solution may be controlled by adding water and/or additional amounts of the silicate, acid concentrate solution.

### EXAMPLE 1

Fresh cultures of Listeria spp. was isolated from spoiled meat and suspended in BHIM broth at about 5 log/ml, sodium metasilicate pentahydrate and lactic acid solution was added to the inoculated BHIM broth in a series of dilutions to give respective final concentrations in the broth of 0, 0.05, 1, and 2 wt % sodium metasilicate pentahydrate and equal parts of lactic acid solution. The cells were treated in the sodium metasilicate pentahydrate and lactic acid solution containing broth at room temperature for 5 min and then were removed from the system by centrifugation. The cells were then re-suspended and washed once in BHIM broth and plated on Oxford Medium, Modified plates (OMM). The plate count was performed after incubation at 30° C. for 48 hours. Results are given below in TABLE 1 as colony forming units per milliliter (CFU/ml) log reduction.

TABLE 1

| | | Listeria |
|---|---|---|
| | | spp. |
| Sodium | | 5 log |
| metasilicate | | |
| pentahydrate | | |
| & Lactic acid | | |
| | | CFU/ml |
| Solution | | log |
| concentration | pH | reduction |
| 0% | 7.6 | 1 |
| concentration | | |
| 0.05% | 7.2 | 2 |
| concentration | | |
| 1% | 7 | 4 |
| concentration | | |
| 2% | 6.8 | 5 |
| concentration | | |

The number of Listeria colonies determined from the plating appear to be very consistent. The numbers recovered were close to what was theoretically put on showing that even the water rinse did remove some bacteria. There did not appear to be any background contaminants growing on the plates—all colonies looked similar and typical of Listeria spp.

The neutralized silicate rinse provided a reduction in Listeria spp. count compared to the control count, with the 2% treatment providing a greater reduction in Listeria spp. count than the 1% treatment.

### EXAMPLE 2

E.COLI (ATCC 10798 K-12 strain) was prepared with LB broth at about 6 log/ml, per 1000 ml of broth. Two kilograms of romaine lettuce hearts were washed in sterile water and let dry in a cooled 1.6° C. sterilized cooler for 2 days. The romaine hearts were then removed and inoculated with the E.COLI broth of 500 ml per kilogram and left to grow in cool 3.3° C. cooler for 4 days. The romaine hearts were then removed and dunked into 18 liter chilled water bath of 3.3° C. for 30 seconds 400 grams of romaine hearts per series of solution. After dunking the romaine hearts were removed and spin dried to remove excess water. Solutions of sodium metasilicate pentahydrate and equal amounts of citric acid were prepared at 0 wt %, 0.5 wt %, wt %, 2 wt % and 4 wt %. After spin drying the romaine hearts were liquefied and plated on LB agar plates. The plate count was performed after incubation at 30° C. for 48 hours. Results are given below in TABLE 2 as colony forming units per milliliter (CFU/ml) log reduction.

TABLE 2

| | | E. COLI 6 |
|---|---|---|
| | | log |
| Sodium metasilicate | | CFU/ml |
| pentahydrate & Citric | | log |
| acid | pH | reduction |
| 0% concentration | 7.8 | 1 |
| 0.5% concentration | 7.4 | 2 |
| 1% concentration | 7.2 | 3 |
| 2% concentration | 7.1 | 5 |
| 4% concentration | 6.9 | 6 |

The number of E. COLI colonies determined from the plating appears to be very consistent. The numbers recovered were close to what was theoretically put on showing that even the water rinse did remove some bacteria. There did not appear to be any background contaminants growing on the plates—all colonies looked similar and typical of E.COLI.

The neutralized silicate rinse provided a reduction in E.COLI all count compared to the control count, with the 4% treatment providing a greater reduction in E. COLI count than the 2% treatment.

### EXAMPLE 3

E.COLI (ATCC 10798 K-12 strain) was prepared with LB broth at about 5 log/ml. per 1000 ml of broth. Two kilograms of fresh strawberries university variety were washed in sterile water and let dry in a cooled 3.3° C. sterilized cooler for 2 days. The strawberries were then removed and inoculated with the E.COLI broth of 500 ml per kilogram and left to grow in cool 3.3° C. cooler for 4 days. The strawberries were then removed and sprayed with the silicate and acid aqueous solution for 15 seconds until runoff, 400 grams of strawberries per series of solution. After spraying the strawberries were removed and allowed to drip dry to remove excess solution. Solutions of sodium metasilicate pentahydrate and equal amounts of ascorbic acid were prepared at 0 wt %, 0.5 wt %, 1 wt %, 2 wt % and 4 wt %. After drying the strawberries were liquefied and plated on LB agar plates. The plate count was performed after incubation at 30° C. for 48 hours. Results are given below in TABLE 3 as colony forming units per milliliter (CFU/ml) log reduction.

TABLE 3

| Sodium | | E. COLI 5 |
|---|---|---|
| metasilicate | | log |
| pentahydrate | | CFU/ml |
| & Ascorbic | | log |
| acid | pH | reduction |
| 0% | 7.7 | 1 |
| concentration | | |
| 0.5% | 7.4 | 1.5 |
| concentration | | |
| 1% | 7.3 | 3 |
| concentration | | |
| 2% | 7.2 | 4.5 |
| concentration | | |
| 4% | 7 | 4.5 |
| concentration | | |

The number of E.COLI colonies determined from the plating appears to be very consistent. The numbers recovered were close to what was theoretically put on showing that even the water rinse did remove some bacteria. There did not appear to be any background contaminants growing on the plates all colonies looked similar and typical of E.COLI.

The neutralized silicate rinse provided a reduction in E. COLI count compared to the control count, with the 4% treatment providing a greater reduction in E.COLI count than the 2% treatment.

### EXAMPLE 4

Fresh cultures of Listeria spp. was isolated from spoiled meat and suspended in BHIM broth at about 5 log/ml sodium metasilicate pentahydrate and lactic acid solution was added to the inoculated BHIM broth in a series of dilutions to give respective final concentrations in the broth of 0, 0.005, 0.01, and 0.02 wt % sodium metasilicate pentahydrate and equal parts of lactic acid solution. Oxford Medium, Modified plates (OMM) were treated with the neutralized silicate aqueous solution in the center of about 1 cm. Cultured broth of 1 ml was added to the plate and incubated for at 30° C. for 48 hours. After examination the cell growth was surrounding the neutralized silicate solution but not growing in the neutralized silicate solution thus indicating inhibition effect towards cell growth.

### EXAMPLE 5

Botrytis cinerea culture samples were isolated prepared from strawberries and grown on agar plates at 21° C. for 48 hours. An inoculation was prepared by adding the culture agar to sterile water 1 ml to 1 ml a total of 500 ml of culture water solution. Two kilograms of fresh strawberries university variety were prepared in 400 gram quantities and sprayed until runoff with five prepared silicate acid aqueous solutions. Solutions of sodium metasilicate pentahydrate and equal amounts of ascorbic acid solutions were prepared at 0 wt %, 0.5 wt %, 1 wt %, 2 wt % and 4 wt %. After drip drying and average moisture weight is 0.001 wt % to 0.005 wt % of total material weight and the silicate acid coated strawberries were then inoculated with 100 ml of cultured water solution and allowed to incubate at 21° C. for 24 hours. After incubation a colony count was performed on the whole strawberries and results are given below in TABLE 4 as colony forming units per gram (CFU/g).

TABLE 4

| Sodium | | |
|---|---|---|
| metasilicate | | Botrytis |
| pentahydrate | | cinerea |
| & Ascorbic | | CFU/g |
| acid | pH | Growth |
| 0% | 7.7 | 10000> |
| concentration | | |
| 0.5% | 7.4 | 2020 |
| concentration | | |
| 1% | 7.3 | 1090 |
| concentration | | |
| 2% | 7.2 | 143 |
| concentration | | |
| 4% | 7 | 10< |
| concentration | | |

The growth of Botrytis cinerea colonies from the inoculation appears to be consistent. The numbers growing were close to what is theoretically for this type of substrate. Humidity and temperature were held a constant for the given period of testing. There did not appear to be any background contaminants growing on the substrate all colonies looked similar and typical of Botrytis cinerea.

The neutralized silicate rinse provided a inhibition in Botrytis cinerea growth as compared to the 0% aqueous solution only. The 4% neutralized silicate treatment providing a greatest inhibition in Botrytis cinerea count than the 2% treatment.

### EXAMPLE 6

Botrytis cinerea culture samples were isolated prepared from strawberries and grown on agar plates at 21° C. for 48 hours. An inoculation was prepared by adding the culture agar to sterile water 1 ml to 1 ml a total of 500 ml of culture water solution. Two kilograms of fresh romaine lettuce hearts were prepared in 400 gram quantities and sprayed until runoff with five prepared silicate acid aqueous solutions. Solutions of sodium metasilicate pentahydrate and equal amounts of citric acid solutions were prepared at 0 wt %, 0.5 wt %, 1 wt %, 2 wt % and 4 wt %. After drip drying and average moisture weight is 0.001 wt % to 0.005 wt % of total material weight and the silicate acid coated fresh romaine lettuce hearts were then inoculated with 100 ml of cultured water solution and allowed to incubate at 21° C. for 24 hours. After incubation a colony count was performed and results are given below in TABLE 5 as colony forming units per gram (CFU/g).

TABLE 5

| Sodium | | Botrytis |
|---|---|---|
| metasilicate | | cinerea |
| pentahydrate | | CFU/g |
| & Citric acid | pH | Growth |
| 0% | 7.8 | 5000> |
| concentration | | |
| 0.5% | 7.6 | 950 |
| concentration | | |
| 1% | 7.4 | 154 |
| concentration | | |
| 2% | 7.1 | 85 |
| concentration | | |
| 4% | 6.9 | 10< |
| concentration | | |

The growth of Botrytis cinerea colonies from the inoculation appears to be consistent. The numbers growing were close to what is theoretically for this type of substrate. Humidity and temperature were held a constant for the given period of testing. There did not appear to be any background contaminants growing on the substrate all colonies looked similar and typical of Botrytis cinerea.

The neutralized silicate rinse provided an inhibition in Botrytis cinerea growth as compared to the 0% aqueous solution only. The 4% neutralized silicate treatment providing a greatest inhibition in in Botrytis cinerea count than the 2% treatment

We claim:

1. A method for treating fresh fruits and fresh vegetables products to reduce bacterial and or fungal contamination of the fresh fruits and fresh vegetables or to retard bacterial and or fungal growth on the fresh fruits and fresh vegetables products, comprising contacting the fresh fruits and fresh vegetables products with an aqueous solution in an amount effective to reduce said contamination or to retard said growth, said aqueous solution consisting essentially of a silicate and an acid.

2. The method of claim 1, wherein the silicate comprises one or more of anhydrous sodium metasilicate, anhydrous potassium metasilicate, sodium metasilicate pentahydrate and potassium metasilicate pentahydrate.

3. The method of claim 1, wherein the acid comprises one or more of sorbic acid, benzoic acid, lactic acid, citric acid, ascorbic acid and salicylic acid.

4. The method of claim 1, wherein said silicate comprises from 0.005 wt. % to 10 wt. % of said composition

5. The method of claim 1, wherein said acid comprises from 0.005 wt. % to 10 wt. % of said composition

6. The method of claim 1, wherein said silicate acid composition has a pH between 6.5 and 7.8

7. The method of claim 1, wherein the aqueous solution is at a temperature of from −2 to about 25° C.

8. The method of claim 1, wherein the aqueous silicate is not polymerized.

9. A method for treating fresh fruits and fresh vegetables products to reduce bacterial and or fungal contamination of the fresh fruits and fresh vegetables or to retard bacterial and or fungal growth on the fresh fruits and fresh vegetables products, comprising contacting the fresh fruits and fresh vegetables products with an aqueous solution in an amount effective to reduce said contamination or to retard said growth, said aqueous solution consisting essentially of a silicate and an acid where said silicate and acid solution have dehydrated to form an inhibitory protective coating.

10. The method of claim 9, wherein the silicate comprises one or more of anhydrous sodium metasilicate, anhydrous potassium metasilicate, sodium metasilicate pentahydrate and potassium metasilicate pentahydrate.

11. The method of claim 9, wherein the acid comprises one or more of sorbic acid, benzoic acid, lactic acid, citric acid, ascorbic acid and salicylic acid.

12. The method of claim 9, wherein said silicate comprises from 0.0005 wt. % to 1 wt. % of said composition

13. The method of claim 9, wherein said acid comprises from 0.0005 wt. % to 1 wt. % of said composition

14. The method of claim 9, wherein said silicate acid composition has a pH between 6.5 and 7.8

15. The method of claim 9, wherein the aqueous solution is at a temperature of from −2 to about 25° C.

16. The method of claim 9, wherein said silicate acid solution applied to the fresh fruit and or fresh vegetable has been allowed to dry to a moisture content of 0.001 wt % to 0.005 wt % of total material weight.

17. The method of claim 9, wherein the aqueous solution comprises one or more of a softening agent sodium bicarbonate and potassium bicarbonate.

18. The method of claim 9, wherein said softening agent comprises from 0.005 wt % to 0.01 wt % of said composition

19. The method of claim 9, wherein the aqueous solution comprises one or more of a surfactant sodium lauryl sulfate and quillaja saponaria,

20. The method of claim 9, wherein said surfactant comprises from 0.0005 wt % to 0.01 wt % of said composition
